(19) United States
(12) Patent Application Publication
(10) Pub. No.: US 2026/0043749 A1
(43) Pub. Date: Feb. 12, 2026

(54) METHOD AND APPARATUS FOR INSPECTING DISPLAY PANEL

(71) Applicants: Samsung Display Co., Ltd., Yongin-si (KR); Korea University Research And Business Foundation, Seoul (KR)

(72) Inventors: Ilhoo Park, Yongin-si (KR); Sanghoon Yim, Yongin-si (KR); GyeTae Kim, Seoul (KR); Yunjae Choi, Seoul (KR); Hyeran Cho, Seoul (KR); Jinwoo Ahn, Seoul (KR); Seungyeol You, Seoul (KR)

(21) Appl. No.: 19/291,462

(22) Filed: Aug. 5, 2025

(30) Foreign Application Priority Data
Aug. 9, 2024 (KR) 10-2024-0107087

(51) Int. Cl. G01N 21/95; G01N 21/88

(52) U.S. Cl. CPC G01N 21/95; G01N 2021/8887

(57) ABSTRACT

A method of inspecting a display panel and an apparatus for the same are provided. The method including obtaining luminance data by measuring, over time, luminance of a display area of the display panel to which an input signal including a plurality of pulses is applied, obtaining pairs of a first-order differential value with respect to time and a second-order differential value with respect to time from the luminance data or from a graph of luminance over time corresponding to the luminance data, obtaining a response graph based on the pairs by setting one of an x-axis and a y-axis as an axis of the first-order differential value with respect to time and the other as an axis of the second-order differential value with respect to time, and determining whether the display panel is normal or not according to the response graph.

### CROSS-REFERENCE TO RELATED APPLICATION

The present application claims priority to and the benefit of Korean Patent Application No. 10-2024-0107087, filed on Aug. 9, 2024, in the Korean Intellectual Property Office, the entire disclosure of which is incorporated by reference herein.

### BACKGROUND

### 1. Field

One or more embodiments relate to a method and an apparatus, for inspecting a display panel and an electronic device including the same, and more particularly, to a method and an apparatus, for inspecting a display panel, allowing it to be determined quickly whether a display panel is normal or not.

### 2. Description of the Related Art

In general, a display panel includes a display area that displays an image. Many pixels are arranged in the display area, and when the pixels include defective pixels, the quality of an image implemented by the display panel is bound to deteriorate. Accordingly, during a process of manufacturing the display panel, it is necessary to go through a process of determining whether the display area is operating normally.

### SUMMARY

However, a method and apparatus for inspecting a display panel, according to the related art, requires a lot of time to obtain and analyze data for inspection.

To solve various problems including the above problem, one or more embodiments of the present disclosure provide a method and apparatus for inspecting a display panel, in which whether a display panel is normal or not may be determined quickly. However, such a technical problem is an example, and the present disclosure is not limited thereto.

Additional aspects will be set forth in part in the description which follows and, in part, will be apparent from the description, or may be learned by practice of embodiments of the present disclosure.

According to one or more embodiments, a method of inspecting a display panel includes obtaining luminance data by measuring, over time, luminance of a display area of the display panel to which an input signal including a plurality of pulses is applied, obtaining pairs of a first-order differential value with respect to time and a second-order differential value with respect to time, from the luminance data or from a graph of luminance over time corresponding to the luminance data, obtaining a response graph based on the pairs by setting one of an x-axis and a y-axis as an axis of the first-order differential value with respect to time and the other as an axis of the second-order differential value with respect to time, and determining whether the display panel is normal or not according to the response graph.

The determining may include determining whether the display panel is normal or not, based on an internal area of the response graph.

The determining may include determining the display panel to be abnormal, when the internal area of the response graph is greater than a preset value.

The determining may include determining the display panel to be abnormal, when a maximum width of the response graph in an x-axis direction is greater than a preset value.

The determining may include determining the display panel to be abnormal, when a maximum width of the response graph in a y-axis direction is greater than a preset value.

The determining may include determining the display panel to be abnormal, when a maximum value of the response graph in an x-axis direction is greater than a preset maximum value, or when a minimum value of the response graph in the x-axis direction is less than a preset minimum value.

The determining may include determining the display panel to be abnormal, when a maximum value of the response graph in a y-axis direction is greater than a preset maximum value, or when a minimum value of the response graph in the y-axis direction is less than a preset minimum value.

The obtaining of the pairs may include obtaining the pairs by inputting the luminance data to a differential circuit unit.

According to one or more embodiments, an apparatus for inspecting a display panel includes an input signal application unit configured to apply an input signal including a plurality of pulses to the display panel, a luminance measurement unit configured to measure luminance of a display area of the display panel over time, and a differential circuit unit configured to differentiate, with respect to time, luminance data over time obtained by the luminance measurement unit, wherein whether the display panel is normal or not is determined using pairs of a first-order differential value with respect to time and a second-order differential value with respect to time of the luminance data over time obtained by the luminance measurement unit, the pairs being obtained by the differential circuit unit.

A response graph may be obtained based on the pairs by setting one of an x-axis and a y-axis as an axis of the first-order differential value with respect to time and the other as an axis of the second-order differential value with respect to time, wherein whether the display panel is normal or not may be determined based on the response graph.

Whether the display panel is normal or not may be determined based on an internal area of the response graph.

The display panel may be determined to be abnormal when the internal area of the response graph is greater than a preset value.

The display panel may be determined to be abnormal when a maximum width of the response graph in an x-axis direction is greater than a preset value.

The display panel may be determined to be abnormal when a maximum width of the response graph in a y-axis direction is greater than a preset value.

The display panel may be determined to be abnormal when a maximum value of the response graph in an x-axis direction is greater than a preset maximum value, or when a minimum value of the response graph in the x-axis direction is less than a preset minimum value.

The display panel may be determined to be abnormal when a maximum value of the response graph in a y-axis direction is greater than a preset maximum value, or when a minimum value of the response graph in the y-axis direction is less than a preset minimum value.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a schematic block diagram of an electronic apparatus according to an embodiment;

FIG. 2 is a schematic view of electronic apparatuses according to embodiments;

FIG. 3 is a schematic view showing examples of wearable electronic apparatuses as electronic apparatuses according to embodiments;

FIG. 4 is a schematic view showing examples of vehicle electronic apparatuses as electronic apparatuses according to embodiments;

FIG. 5 is a schematic plan view of a display panel to be inspected;

FIG. 6 is a graph of luminance over time based on data obtained by turning-on red sub-pixels of the display panel of FIG. 5 to emit light;

FIG. 7 is a response graph obtained using the graph of FIG. 6;

FIG. 8 is a graph of luminance over time based on data obtained by turning-on green sub-pixels of the display panel of FIG. 5 to emit light;

FIG. 9 is a response graph obtained using the graph of FIG. 8;

FIG. 10 is a graph of luminance over time based on data obtained by turning-on blue sub-pixels of the display panel of FIG. 5 to emit light;

FIG. 11 is a response graph obtained using the graph of FIG. 10;

FIG. 12 is a schematic block diagram of an apparatus for inspecting a display panel, according to one or more embodiments; and

FIG. 13 is a circuit diagram showing a differential circuit unit that may be included in the apparatus of FIG. 12.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein.

Accordingly, the embodiments are merely described below, by referring to the figures, to explain aspects of the present disclosure. As used herein, the term “and/or” includes any and all combinations of one or more of the associated listed items. Throughout the present disclosure, the expression “at least one of a, b or c” indicates only a, only b, only c, both a and b, both a and c, both b and c, all of a, b, and c, or variations thereof.

As the present disclosure allows for various changes and numerous embodiments, certain embodiments will be illustrated in the drawings and described in the written description. Effects and features of one or more embodiments and methods of accomplishing the same will become apparent from the following detailed disclosure of the one or more embodiments, taken in conjunction with the accompanying drawings. However, embodiments of the present disclosure may have different forms and should not be construed as being limited to the descriptions set forth herein.

One or more embodiments will be described below in more detail with reference to the accompanying drawings. Those elements that are the same or are in correspondence with each other are rendered the same reference numeral regardless of the figure number, and redundant descriptions thereof are omitted.

It will be understood that, when an element, such as a layer, a film, a region, or a plate, is referred to as being “on” another element, it may be “directly on” the other element, or intervening elements may be present therebetween. In addition, sizes of elements in the drawings may be exaggerated or reduced for convenience of explanation. For example, because sizes and thicknesses of elements in the drawings are arbitrarily illustrated for convenience of description, the following embodiments are not limited thereto.

The x-axis, the y-axis, and the z-axis are not limited to three axes of the rectangular coordinate system and may be interpreted in a broader sense. For example, the x-axis, the y-axis, and the z-axis may be perpendicular to one another or may represent different directions that are not perpendicular to one another.

While such terms as “first” and “second” may be used to describe various elements, such elements must not be limited to the above terms. The above terms are used only to distinguish one element from another.

It will be further understood that the terms “include,” “comprise,” and “have” as used herein specify the presence of stated features or elements but do not preclude the addition of one or more other features or elements.

As used herein, the expression “A and/or B” refers to A, B, or A and B. In addition, the expression “at least one of A and B” refers to A, B, or A and B.

It will be further understood that, when layers, regions, or elements are referred to as being connected to each other, they may be directly connected to each other or may be indirectly connected to each other with intervening layers, regions, or elements therebetween. For example, when layers, regions, or elements are referred to as being electrically connected to each other, they may be directly electrically connected to each other or may be indirectly electrically connected to each other with intervening layers, regions, or elements therebetween.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

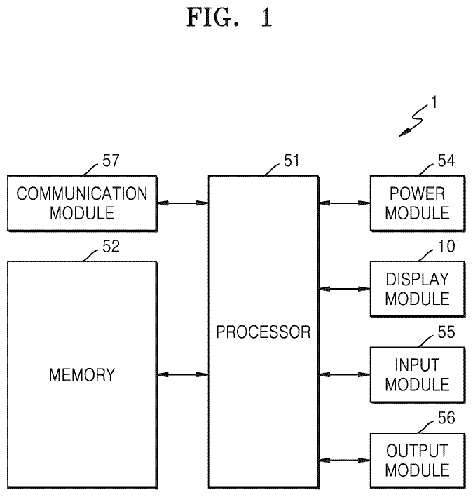

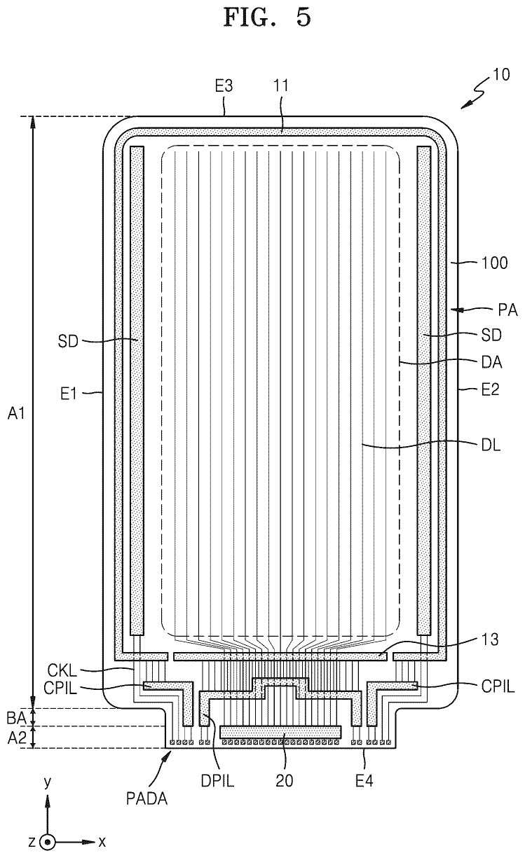

FIG. 1 is a schematic block diagram of an electronic apparatus 1 including a display module 10′ having a display panel 10 (see FIG. 5) to be inspected. The electronic apparatus 1 may be a display apparatus or may further include, in addition to the display module 10′, a module and the like having another additional function than that of the display module 10′.

As shown in FIG. 1, the electronic apparatus 1 may include the display module 10′, a processor 51, a memory 52, a power module 54, an input module 55, an output module 56, and a communication module 57.

The display module 10′ may include a display panel 10 as described below. As an example, the display module 10′ may include the display panel 10, a driving chip 20 mounted thereon, and the like. The display panel 10 is described below.

The processor 51 may control most of elements of the electronic apparatus 1. As an example, the processor 51 may output digital video data to the display module 10′ such that the display module 10′ displays images, and may receive input data from the input module 55 to allow a function corresponding to the relevant data to be performed by the electronic apparatus 1. The processor 51 may include at least one of a central processing unit (CPU), an application processor (AP), a graphic processing unit (GPU), a communication processor (CP), an image signal processor (ISP), and a controller.

When needed, the processor 51 may be divided into two or more portions in a functional or structural viewpoint. As an example, the processor 51 may include a main processor in the form of a first driving chip including a central processing unit, and an auxiliary processor in the form of a second driving chip, which is a portion of the display module 10′. The auxiliary processor in the form of the second driving chip may include a controller receiving image signals from the main processor and processing image signals to match interface specifications of the display panel 10 included in the display module 10′.

The memory 52 may include at least one of a non-volatile memory and a volatile memory. The memory 52 may store data information required for operations of the processor 51 or the display module 10′. When the processor 51 executes an application stored in the memory 52, data signals for images and/or an input control signal may be transferred to the display module 10′, and the display module 10′ may process provided signals and output image information.

The power module 54 may include a power supply module such as a power adapter or a battery unit, and a power converting module converting power supplied by the power supply module and generating power required for operations of the electronic apparatus 1. Power conversion by the power converting module may include DC-DC conversion, AC-DC conversion, or DC-AC conversion. However, the disclosure is not limited thereto.

The input module 55 may provide input information to the processor 51 and/or the display module 10′. The input module 55 may include not only a physical button, a keyboard, and a microphone, but also various kinds of sensor modules. Examples of the sensor module may include a touch sensor, a pressure sensor, a distance sensor, a position sensor, a digitizer, a motion recognition sensor, a camera sensor, a light reception sensor, a photoelectric conversion sensor, and/or a temperature sensor. In addition, the sensor module may include biometric sensors such as a blood pressure sensor, a blood sugar sensor, an electrocardiogram sensor, and/or a heart rate sensor.

The output module 56 may receive information other than images received from the processor 51 and may provide the information to a user. The output module 56 may include, for example, a sound module, a haptic module, and/or a light-emitting module. In addition, the output module 56 may include a unique functional module of the electronic apparatus 1 such as a cooling module of a refrigerator.

For reference, the display module 10′ may be also in charge of an output function. As an example, the display panel 10 included in the display module 10′ may display (output) information processed by the electronic apparatus 1. As an example, the display panel 10 may display execution screen information of an application driven by the electronic apparatus 1, a user interface (UI), or graphic user interface (GUI) information corresponding to the execution screen information. The display panel 10 may include a display layer and a touchscreen layer, wherein the display layer displays images, and the touchscreen layer senses a user's touch input. Accordingly, the display panel 10 may serve as a portion of the input module 55 that provides an input interface between the electronic apparatus 1 and a user, and simultaneously, serve as a portion of the output module 56 that provides an output interface between the electronic apparatus 1 and a user.

The communication module 57 is a module responsible for transmission/reception of information between the electronic apparatus 1 and an external apparatus, and may include a receiver and a transmitter. The communication module 57 may include various kinds of wireless communication modules such as a mobile communication module, a broadcasting reception module, a wireless Internet module, a short range communication module, a Wi-Fi module, and/or a Bluetooth module, or various kinds of wired communication modules.

The electronic apparatus 1 shown in FIG. 1 is just an example. As an example, a display apparatus not having a communication function may not include the communication module 57. In addition, in the case where the electronic apparatus 1 includes a display apparatus, at least one of elements of the electronic apparatus 1 may be included in the display apparatus. In addition, some of individual modules functionally included in one module may be included in the display apparatus, and other some may be included in the electronic apparatus 1 separately from the display apparatus. As an example, the display apparatus may include the display module 10′, and the processor 51, the memory 52, and the power module 54 may be elements of the electronic apparatus 1, not the display apparatus. Alternatively, the display apparatus may include the display module 10′ and the power module 54, and the power module 54 may supply power to the elements such as the processor 51 and the memory 52 of the electronic apparatus 1. However, various modifications may be made.

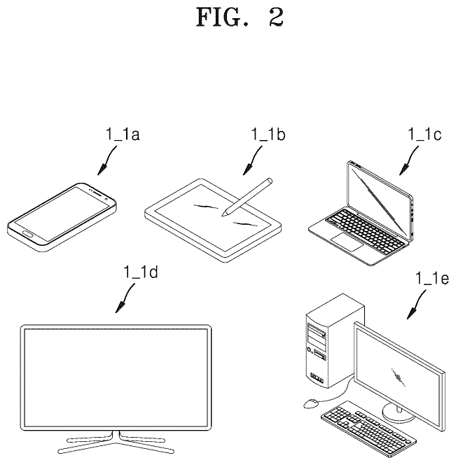

FIG. 2 is a schematic view of the electronic apparatuses 1. FIG. 2 shows, as an example of the electronic apparatus 1, a smartphone 1_1a, a tablet personal computer (PC) 1_1b, a laptop 1_1c, a TV 1_1d, and a desk monitor 1_1e.

The smartphone 1_1a may include not only the processor 51, the memory 52, the power module 54, and the display module 10′, but also the input module 55 such as a touch sensor, and the communication module 57. The smartphone 1_1a may process information received through the communication module 57 or other input modules and display the information through the display module 10′.

Similar to the smartphone 1_1a, the tablet personal computer (PC) 1_1b, the laptop 1_1c, the TV 1_1d, and/or the desk monitor 1_1e may include the display module 10′ and the input module 55 and may include the communication module 57 depending on a case.

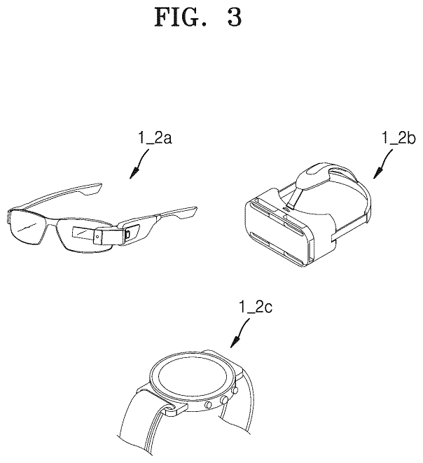

FIG. 3 is a schematic view showing a case where electronic apparatuses 1 are wearable electronic apparatuses. FIG. 3 shows, as an example of the electronic apparatus 1, a smartglasses 1_2a, a head mount display 1_2b, and a smartwatch 1_2c.

The smartglasses 1_2a and the head mount display 1_2b may include the display module 10′ displaying images, and a reflector reflecting light from a display surface of the display module 10′ displaying images and providing the images to a user's eyes. A user may experience virtual reality or augmented reality using the electronic apparatus 1.

The smartwatch 1_2c may include a biometric sensor as the input module 55 and provide, through the display module 10′, a user with bio information recognized through the biometric sensor.

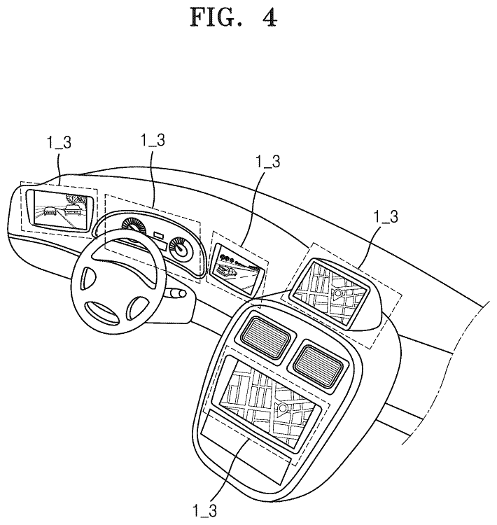

FIG. 4 is a schematic view showing a case where the electronic apparatus 1 are a vehicle electronic apparatus1_3. As shown in FIG. 4, the vehicle electronic apparatus 1_3 may be included in an instrument board, a center facia or the like of an automobile, or may be a center information display (CID) disposed on a dashboard of an automobile or a room mirror display replacing a side mirror.

However, the electronic apparatus 1 is not limited thereto. As an example, the electronic apparatus 1 may include not only apparatuses centered on displays such as billboards, electronic boards, and/or game consoles, but also various home appliances that display information through a display module 10′, such as a refrigerator, a washing machine, a dryer, an air conditioner, and/or a robot vacuum cleaner. In addition, in the case where the display module 10′ has a function of transmitting light, the electronic apparatus 1 may be a smart window or a transparent display apparatus displaying a background and display images together. However, the electronic apparatus 1 according to the disclosure is not limited thereto. As long as the electronic apparatus 1 includes the display panel 10 described below, any electronic apparatus may fall within the scope of the disclosure.

FIG. 5 is a schematic plan view of a display panel 10 to be inspected. The display panel 10 to be inspected may itself be a final product as a display apparatus or may be part of another display apparatus. In the latter case, the display apparatus may be any apparatus including the display panel 10. For example, the display apparatus may be any of various products such as a smartphone, a tablet, a laptop, a television, a billboard, a vehicle instrument panel, and/or a vehicle display apparatus.

The display panel 10 may include a display area DA in which a plurality of pixels are arranged and a peripheral area PA outside the display area DA along an edge or a periphery of the display area DA. It may be understood as meaning that a substrate 100 of the display panel 10 includes the display area DA and the peripheral area PA.

The peripheral area PA includes a pad area PADA to which an electronic element such as a driving chip 20 or a printed circuit board (PCB) is electrically attached. In addition, a scan driver SD, a common voltage input line CPIL, a common voltage supply line 11, a driving voltage input line DPIL, and a driving voltage supply line 13 may also be arranged in the peripheral area PA. Various wires including a clock signal line CKL to be input to the scan driver SD may also pass through the peripheral area PA.

The driving chip 20 may include an integrated circuit (IC) configured to drive the display panel 10. The integrated circuit may be a data driving integrated circuit configured to generate a data signal, but the present disclosure is not limited thereto. The substrate 100 may include a first edge E1 and a second edge E2 extending approximately in a first direction (a y-axis direction) and facing each other and may also include a third edge E3 and a fourth edge E4 extending approximately in a second direction (an x-axis direction) crossing the first direction and connecting the first edge E1 and the second edge E2 to each other. The driving chip 20 may be mounted in the peripheral area PA to be adjacent to the fourth edge E4 of the substrate 100.

For reference, FIG. 5 may also be understood as a plan view of the substrate 100, etc., in a manufacturing process. In a finally-manufactured display apparatus or an electronic apparatus such as a smartphone including a display apparatus, part of a substrate 100, etc., may be bent to reduce the area of the peripheral area PA to be recognized by a user. For example, the peripheral area PA may include a bending area BA so that the bending area BA may be between the pad area PADA and a main display area. In this case, the substrate 100 may be bent in the bending area BA, and thus, a first area A1 on one side of the bending area BA and a second area A2 on the other side of the bending area BA may overlap each other.

For example, the substrate 100 may be bent in the bending area BA, and thus, at least a portion of the second area A2 in which the pad area PADA is positioned may overlap the first area A1 in which the display area DA is positioned. In this case, a bending direction is set to position the pad area PADA behind the display area DA, etc. Accordingly, a user perceives the display area DA as taking up most of the display apparatus. Although the driving chip 20 described above is mounted on a surface that is the same as a display surface of the display area DA, the driving chip 20 may be positioned in a rear direction of the display area DA as the display panel 10 is bent in the bending area BA.

The substrate 100 may include various materials having flexible or bendable characteristics, and for example, may include polymer resin such as polyethersulfone, polyacrylate, polyetherimide, polyethylene naphthalate, polyethylene terephthalate, polyphenylene sulfide, polyarylate, polyimide, polycarbonate, and/or cellulose acetate propionate. The substrate 100 may be variously modified, for example, to have a multi-layer structure including two layers including the above polymer resin and a barrier layer between the two layers and including an inorganic material (such as silicon oxide, silicon nitride, and/or silicon oxynitride). Further, when the substrate 100 is not bendable, the substrate 100 may include glass.

The edge of the display area DA may have an overall shape similar to a rectangle or square. Accordingly, the substrate 100 may also have an overall shape similar to a rectangle or square. If necessary, the edge of the display area DA may have a shape such as a circle, an oval, or other polygon.

As described above, the substrate 100 may include the first edge E1 and the second edge E2 extending approximately in the first direction (the y-axis direction) and facing each other and may also include the third edge E3 and the fourth edge E4 extending approximately in the second direction (the x-axis direction) crossing the first direction and connecting the first edge E1 and the second edge E2 to each other. The pad area PADA may be an area of the peripheral area PA of the substrate 100 that is adjacent to the fourth edge E4. If necessary, the substrate 100 may have a bent portion between the first edge E1 and the fourth edge E4 and between the second edge E2 and the fourth edge E4, and thus, the substrate 100, etc., may be easily bent in the bending area BA. Accordingly, as shown in FIG. 5, a width of the substrate 100 in the second direction (the x-axis direction) in the second area A2 may be less than a width of the substrate 100 in the second direction (the x-axis direction) in the first area A1.

Although a case where the display panel 10 to be inspected includes an organic light-emitting device is described below as an example, the display panel 10, which is the subject of a method of inspecting a display panel, according to the present disclosure, is not limited thereto. For example, the display panel 10 may include an inorganic light-emitting device or may include a display element such as a quantum dot light-emitting device. For example, an emission layer of a display element of the display panel 10 may include an organic material or an inorganic material. Alternatively, the display panel 10 may include an emission layer and quantum dots positioned on a path of light emitted from the emission layer.

A plurality of pixels are arranged in the display area DA. Each of the pixels refers to a sub-pixel, and may include a display element such as an organic light-emitting diode (OLED) and a pixel circuit electrically connected to the display element. The pixel may emit, for example, red, green, blue, or white light. The pixel may be electrically connected to outer circuits arranged in the peripheral area PA. The scan driver SD, the common voltage supply line 11, and the driving voltage supply line 13 may be arranged in the peripheral area PA.

The scan driver SD may extend along the first edge E1 of the substrate 100. The scan driver SD may provide a scan signal to the pixels through a scan line extending into the display area DA in the second direction (the x-axis direction). The scan driver SD may also be positioned along the second edge E2 of the substrate 100. In this case, some of the pixels arranged in the display area DA may be electrically connected to the scan driver SD near the first edge E1, and the others may be electrically connected to the scan driver SD near the second edge E2. Alternatively, an emission control driver, rather than the scan driver SD, may be positioned near the second edge E2 of the substrate 100 to provide an emission control signal, etc., to the pixel through an emission control line approximately parallel to the scan line.

A plurality of pads may be arranged in the pad area PADA of the display panel 10. The plurality of pads may not be covered by an insulating layer but may be exposed and electrically connected to a printed circuit board (PCB). That is, pads of the printed circuit board (PCB) may be electrically connected to the plurality of pads of the display panel 10.

The display panel 10 may be inspected in a state where the printed circuit board (PCB) is not electrically connected to the plurality of pads of the display panel 10. That is, after the display panel 10 has been inspected, the printed circuit board (PCB) may be electrically connected to the plurality of pads of the display panel 10. If necessary, inspection may be performed in a state where the printed circuit board (PCB) is attached on the display panel 10. A case where the display panel 10 is inspected in a state where the printed circuit board (PCB) is not electrically connected to the plurality of pads of the display panel 10 is described below.

To inspect the display panel 10, an input signal in the form of a repeating pulse may be applied to the display area DA through a data line DL. Accordingly, a control signal for the same may be applied to the driving chip 20. It may be performed by allowing such a control signal to be input through the plurality of pads of the pad area PADA. Alternatively, when the display panel 10 is inspected before the driving chip 20 is attached to the display panel 10, an input signal in the form of a repeating pulse may be applied to the display area DA through the data line DL by using test pads electrically connected to data lines DL. It may be performed by allowing an input signal in the form of a repeating pulse to be transmitted to the data lines DL through test pads. The test pads may be positioned, for example, in an area where the driving chip 20 is attached.

For such inspection, a related electrical signal may also be applied to the scan driver SD, etc. FIG. 5 shows the clock signal line CKL configured to receive a clock signal through a pad and transmit the clock signal to the scan driver SD. In some cases, the clock signal line CKL may be configured to receive a clock signal from the driving chip 20 and transmit the clock signal to the scan driver SD.

Also, a common voltage may be provided to a common electrode of an organic light-emitting device in the display area DA by providing a common voltage ELVSS to the common voltage supply line 11 through the common voltage input line CPIL. In addition, a driving voltage ELVDD may be provided to the driving voltage supply line 13 through the driving voltage input line DPIL, and thus, a driving voltage may be provided to pixel circuits in the display area DA through a driving voltage line extending from the driving voltage supply line 13 in the first direction (the y-axis direction) to extend into the display area DA. For reference, the common voltage supply line 11 may have a loop shape with one side open in a direction of the fourth edge E4 and may have a shape of extending along the first edge E1, the third edge E3, and the second edge E2.

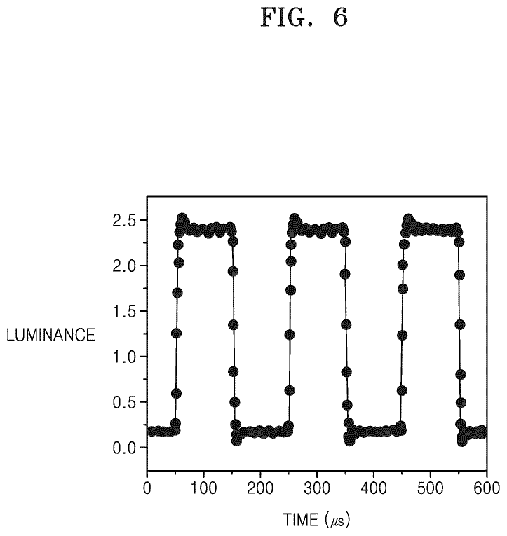

FIG. 6 is a graph of luminance over time based on data obtained by turning-on red sub-pixels of the display panel 10 of FIG. 5 to emit light. In FIG. 6, the horizontal axis represents time, the unit of which is a microsecond (μs), and the vertical axis represents a relative luminance, which is a ratio of the luminance to a preset luminance. The preset luminance, which is reference luminance of the relative luminance, may be variously set as needed.

The display area DA may include red sub-pixels, green sub-pixels, and blue sub-pixels. To test whether the display panel 10 is normal or not, only the sub-pixels that emit light of one of those colors may be allowed to emit light. FIG. 6 is a graph of luminance over time obtained by causing only the red sub-pixels capable of emitting red light to emit light. As described above, an input signal in the form of a repeating pulse may be applied to the display area DA of the display panel 10. Accordingly, as shown in FIG. 6, a graph of luminance of red light over time may also represent a roughly repeating pulse shape. Unlike the input signal, which is a digital signal, measured luminance may not appear in a perfect pulse shape. In particular, when there is a defect in the display panel 10, such as a defect in any of the sub-pixels allowed to emit light, the graph of measured luminance may appear in a shape different from a pulse shape. For example, a slope of a section where luminance increases may be lowered, or an absolute value of a slope of a section where luminance decreases may be lowered.

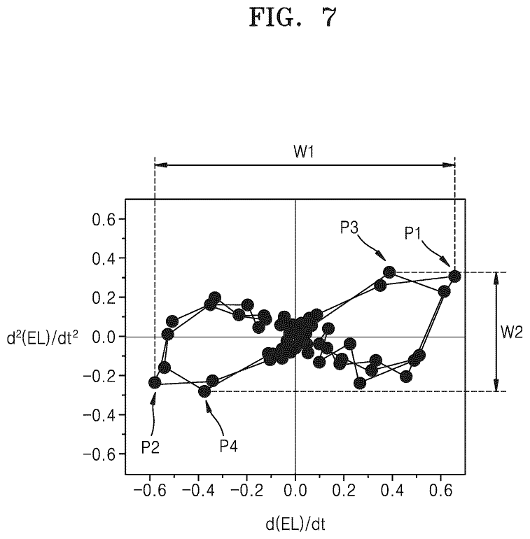

FIG. 7 is a response graph obtained using the graph of FIG. 6. From the graph of luminance over time as shown in FIG. 6, pairs of a first-order differential value of the luminance EL with respect to time d(EL)/dt and a second-order differential value of the luminance EL with respect to time d²(EL)/dt² may be obtained. It may be performed by going through a process of measuring luminance of the display area DA of the display panel 10 to which an input signal in the form of a repeating pulse is applied over time, confirming a closest graph through iteration, etc., by using measured data, and then, differentiating the graph with respect to time. Alternatively, while luminance of the display area DA of the display panel 10 to which an input signal in the form of a repeating pulse is applied is measured over time, a first-order differential value with respect to time may be obtained by inputting measured data to a differential circuit unit described below and a second-order differential value with respect to time may be obtained by inputting the first-order differential value with respect to time to the differential circuit unit, and thus, pairs of the first-order differential value with respect to time and the second-order differential value with respect to time may be obtained.

After pairs of the first-order differential value with respect to time and the second-order differential value with respect to time are obtained as described above, a response graph based on the pairs may be obtained by setting one of the x-axis and the y-axis as an axis of the first-order differential value with respect to time and the other as an axis of the second-order differential value with respect to time. FIG. 7 shows a response graph in which the x-axis is set as an axis of the first-order differential value with respect to time and the y-axis is set as an axis of the second-order differential value with respect to time by using luminance data of the graph shown in FIG. 6. As shown in FIG. 7, the response graph may appear in a shape obtained by rotating the number ‘8’ approximately by 90 degrees.

In the response graph of FIG. 7, relatively many points are positioned near the origin because points corresponding to a part of the pulse-shaped luminance graph of FIG. 6 in which luminance is maintained approximately constant are positioned near the origin in the response graph of FIG. 7. Points far from the origin in FIG. 7 may correspond to a part of the pulse-shaped luminance graph of FIG. 6 in which luminance increases or decreases. More specifically, points in the first and fourth quadrants of FIG. 7 may correspond to a part of the pulse-shaped luminance graph of FIG. 6 in which luminance increases, and points in the second and third quadrants of FIG. 7 may correspond to a part of the pulse-shaped luminance graph of FIG. 6 in which luminance decreases.

In this way, using the response graph shown in FIG. 7, it may be determined whether red sub-pixels in the display area DA of the display panel 10 are normal or not. For example, depending on the internal area of the response graph as shown in FIG. 7, whether the display panel 10 is normal or not may be determined. More specifically, when the internal area of the response graph as shown in FIG. 7 is greater than a preset value, the display panel 10 may be determined to be abnormal. That is, when the internal area of the response graph as shown in FIG. 7 is greater than a preset value, it may be determined that there are abnormal red sub-pixels from among the red sub-pixels of the display panel 10.

In the pulse-shaped luminance graph of FIG. 6, as a slope of a luminance rising (or increasing) section decreases, or an absolute value of a slope of a luminance falling (or decreasing) section decreases, display elements in the display area DA may be regarded as not operating accurately according to an input signal in the form of a repeating pulse. As described above, points far from the origin in FIG. 7 may correspond to a part of the pulse-shaped luminance graph of FIG. 6 in which luminance increases or decreases. Accordingly, an increase in the internal area of the response graph shown in FIG. 7 may be construed as the presence of many pixels in the display area DA that do not operate accurately according to an input signal in the form of a repeating pulse. Therefore, whether the display panel 10 is normal or not may be determined by finding out the presence or absence of defective red sub-pixels or a ratio of defective red sub-pixels from among the red sub-pixels of the display area DA depending on the internal area of the response graph shown in FIG. 7.

Alternatively, when a maximum width W1 of the response graph in the x-axis direction as shown in FIG. 7 is greater than a preset value, the display panel 10 may be determined to be abnormal. In FIG. 7, a difference between an x-coordinate of a first point P1 and an x-coordinate of a second point P2 may be referred to as the maximum width W1 of the response graph in the x-axis direction, and when the maximum width W1 is greater than a preset value, the display panel 10 may be determined to be abnormal.

Alternatively, when a maximum width W2 of the response graph in the y-axis direction as shown in FIG. 7 is greater than a preset value, the display panel 10 may be determined to be abnormal. In FIG. 7, a difference between a y-coordinate of a third point P3 and a y-coordinate of a fourth point P4 may be referred to as the maximum width W2 of the response graph in the y-axis direction, and when the maximum width W2 is greater than a preset value, the display panel 10 may be determined to be abnormal.

Alternatively, when a maximum value (e.g., the x-coordinate of the first point P1) of the response graph in the x-axis direction as shown in FIG. 7 is greater than a preset maximum value, or a minimum value (e.g., the x-coordinate of the second point P2) of the response graph in the x-axis direction as shown in FIG. 7 is less than a preset minimum value, the display panel 10 may be determined to be abnormal.

Alternatively, when a maximum value (e.g., the y-coordinate of the third point P3) of the response graph in the y-axis direction as shown in FIG. 7 is greater than a preset maximum value, or a minimum value (e.g., the y-coordinate of the fourth point P4) of the response graph in the y-axis direction as shown in FIG. 7 is less than a preset minimum value, the display panel 10 may be determined to be abnormal.

Determining whether the display panel 10 is normal or not by measuring luminance for the red sub-pixels of the display area DA of the display panel 10 has been described thus far with reference to FIGS. 6 and 7. The same may also apply to the green sub-pixels or the blue sub-pixels of the display area DA of the display panel 10.

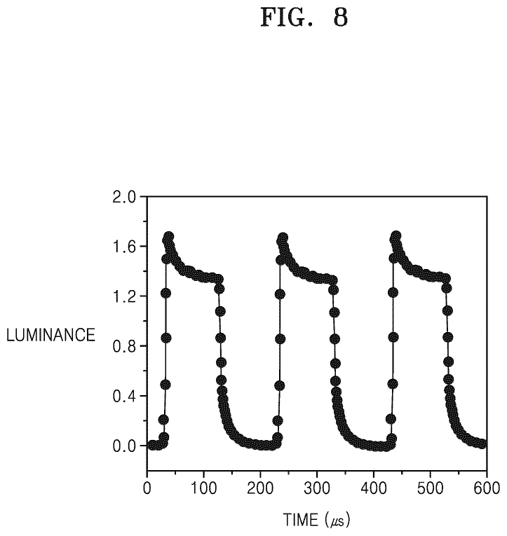

That is, a graph of luminance over time as shown in FIG. 8 may be obtained by turning-on only the green sub-pixels capable of emitting green light to emit light. In FIG. 8, the horizontal axis represents time, the unit of which is a microsecond (μs), and the vertical axis represents a relative luminance, which is a ratio of the luminance to a preset luminance. The preset luminance, which is reference luminance of the relative luminance, may be variously set as needed. FIG. 8 is based on luminance data obtained by applying an input signal in the form of a repeating pulse to the display area DA of the display panel 10 and causing only the green sub-pixels to emit light, and a graph of luminance of green light over time may also represent a roughly repeating pulse shape. Unlike the input signal, which is a digital signal, measured luminance may not appear in a perfect pulse shape. A description thereof is the same as above.

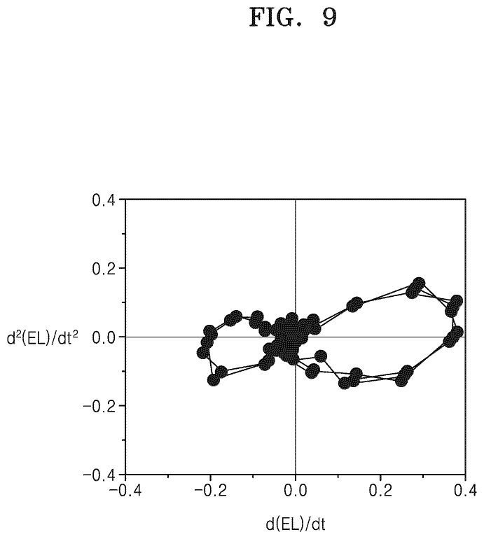

FIG. 9 is a response graph obtained using the graph of FIG. 8. As described above with reference to FIGS. 6 and 7, pairs of a first-order differential value of the luminance EL with respect to time d(EL)/dt and a second-order differential value of the luminance EL with respect to time d²(EL)/dt² may be obtained using the graph of FIG. 8 or luminance data that may be displayed as the graph of FIG. 8. In addition, a response graph based on the pairs may be obtained by setting one of the x-axis and the y-axis as an axis of the first-order differential value with respect to time and the other as an axis of the second-order differential value with respect to time. FIG. 9 shows a response graph in which the x-axis is set as an axis of the first-order differential value with respect to time and the y-axis is set as an axis of the second-order differential value with respect to time by using luminance data of the graph shown in FIG. 8. Also in FIG. 9, in a similar way to FIG. 7, the response graph may appear in a shape obtained by rotating the number ‘8’ approximately by 90 degrees.

Using the response graph shown in FIG. 9, it may be determined whether green sub-pixels in the display area DA of the display panel 10 are normal or not.

For example, depending on the internal area of the response graph as shown in FIG. 9, whether the display panel 10 is normal or not may be determined. More specifically, when the internal area of the response graph as shown in FIG. 9 is greater than a preset value, the display panel 10 may be determined to be abnormal. That is, when the internal area of the response graph as shown in FIG. 9 is greater than a preset value, it may be determined that there are abnormal green sub-pixels from among the green sub-pixels of the display panel 10. In this way, whether the display panel 10 is normal or not may be determined by finding out the presence or absence of defective green sub-pixels or a ratio of defective green sub-pixels from among the green sub-pixels of the display area DA depending on the internal area of the response graph shown in FIG. 9.

Alternatively, when a maximum width of the response graph in the x-axis direction as shown in FIG. 9 is greater than a preset value, the display panel 10 may be determined to be abnormal. Alternatively, when a maximum width of the response graph in the y-axis direction as shown in FIG. 9 is greater than a preset value, the display panel 10 may be determined to be abnormal. Alternatively, when a maximum value of the response graph in the x-axis direction as shown in FIG. 9 is greater than a preset maximum value, or a minimum value of the response graph in the x-axis direction as shown in FIG. 9 is less than a preset minimum value, the display panel 10 may be determined to be abnormal. Alternatively, when a maximum value of the response graph in the y-axis direction as shown in FIG. 9 is greater than a preset maximum value, or a minimum value of the response graph in the y-axis direction as shown in FIG. 9 is less than a preset minimum value, the display panel 10 may be determined to be abnormal.

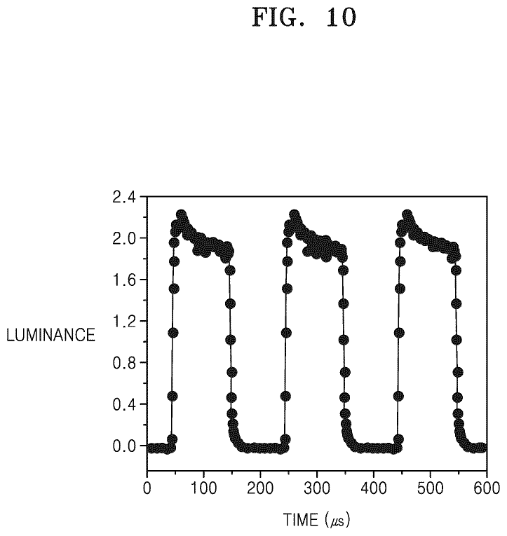

The same applies to the blue sub-pixels. That is, a graph of luminance over time as shown in FIG. 10 may be obtained by turning-on only the blue sub-pixels capable of emitting blue light to emit light. In FIG. 10, the horizontal axis represents time, the unit of which is a microsecond (μs), and the vertical axis represents a relative luminance, which is a ratio of the luminance to a preset luminance. The preset luminance, which is reference luminance of the relative luminance, may be variously set as needed. FIG. 10 is based on luminance data obtained by applying an input signal in the form of a repeating pulse to the display area DA of the display panel 10 and causing only the blue sub-pixels to emit light, and a graph of luminance of blue light over time may also represent a roughly repeating pulse shape. Unlike the input signal, which is a digital signal, measured luminance may not appear in a perfect pulse shape. A description thereof is the same as above.

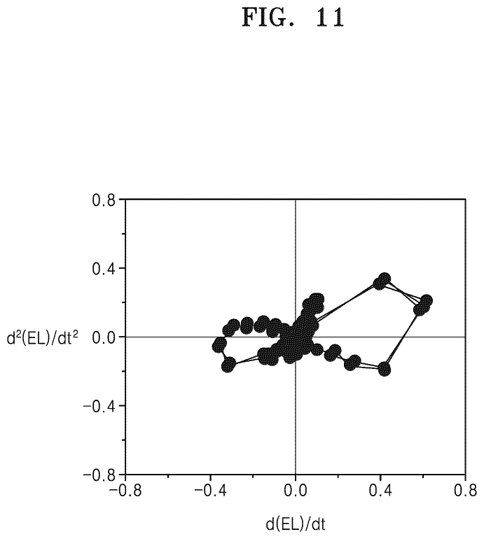

FIG. 11 is a response graph obtained using the graph of FIG. 10. As described above with reference to FIGS. 6 and 7, pairs of a first-order differential value of the luminance EL with respect to time d(EL)/dt and a second-order differential value of the luminance EL with respect to time d²(EL)/dt² may be obtained using the graph of

FIG. 10 or luminance data that may be displayed as the graph of FIG. 10. In addition, a response graph based on the pairs may be obtained by setting one of the x-axis and the y-axis as an axis of the first-order differential value with respect to time and the other as an axis of the second-order differential value with respect to time. FIG. 11 shows a response graph in which the x-axis is set as an axis of the first-order differential value with respect to time and the y-axis is set as an axis of the second-order differential value with respect to time by using luminance data of the graph shown in FIG. 10. Also in FIG. 11, in a similar way to FIG. 7, the response graph may appear in a shape obtained by rotating the number ‘8’ approximately by 90 degrees.

Using the response graph shown in FIG. 11, it may be determined whether blue sub-pixels in the display area DA of the display panel 10 are normal or not.

For example, depending on the internal area of the response graph as shown in FIG. 11, whether the display panel 10 is normal or not may be determined. More specifically, when the internal area of the response graph as shown in FIG. 11 is greater than a preset value, the display panel 10 may be determined to be abnormal.

That is, when the internal area of the response graph as shown in FIG. 11 is greater than a preset value, it may be determined that there are abnormal blue sub-pixels from among the blue sub-pixels of the display panel 10. In this way, whether the display panel 10 is normal or not may be determined by finding out the presence or absence of defective blue sub-pixels or a ratio of defective blue sub-pixels from among the blue sub-pixels of the display area DA depending on the internal area of the response graph shown in FIG. 11.

Alternatively, when a maximum width of the response graph in the x-axis direction as shown in FIG. 11 is greater than a preset value, the display panel 10 may be determined to be abnormal. Alternatively, when a maximum width of the response graph in the y-axis direction as shown in FIG. 11 is greater than a preset value, the display panel 10 may be determined to be abnormal. Alternatively, when a maximum value of the response graph in the x-axis direction as shown in FIG. 11 is greater than a preset maximum value, or a minimum value of the response graph in the x-axis direction as shown in FIG. 11 is less than a preset minimum value, the display panel 10 may be determined to be abnormal. Alternatively, when a maximum value of the response graph in the y-axis direction as shown in FIG. 11 is greater than a preset maximum value, or a minimum value of the response graph in the y-axis direction as shown in FIG. 11 is less than a preset minimum value, the display panel 10 may be determined to be abnormal.

In such a method of inspecting the display panel 10 according to the present

embodiment, luminance in the display area DA is measured by applying an input signal in the form of a repeating pulse to the display panel 10, and then, whether the display panel 10 is normal or not is determined by obtaining the response graph as shown in FIGS. 7, 9 and/or 11. Accordingly, when the method of inspecting the display panel 10 according to the present embodiment is used, luminance is measured for a very short time, and whether the display panel 10 is normal or not is determined based on the luminance. Accordingly, whether the display panel 10 is normal or not may be determined simply, quickly, and intuitively.

The above inspection method may be used not only for the display panel 10 in a manufacturing process but also for a display apparatus including the display panel 10. Accordingly, the above inspection method may be used to not only inspect whether a defect occurs during a process of manufacturing the display panel 10 but also determine whether a display element deteriorates during a process of using the display apparatus.

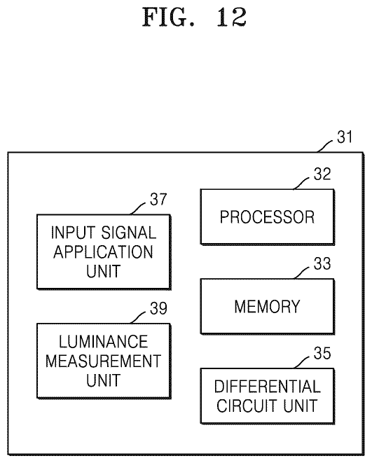

A method of inspecting the display panel 10 in which whether the display panel 10 is normal or not is determined has been described thus far, and thus, an apparatus for inspecting a display panel, which may be used in such a method, also falls within the scope of the present disclosure. FIG. 12 is a schematic block diagram of an apparatus 31 for inspecting a display panel, according to one or more embodiments. The apparatus 31 for inspecting a display panel may include an input signal application unit 37, a luminance measurement unit 39, and a differential circuit unit 35 as shown in FIG. 12. In addition, the apparatus 31 for inspecting a display panel may include a processor 32 and a memory 33.

The processor 32 may use various programs and/or data stored in the memory 33 to perform an operation of generally controlling the apparatus 31 for inspecting a display panel. The processor 32 may include a processing unit such as a microprocessor, a central processing unit (CPU), a processor core, a multiprocessor, an application-specific integrated circuit (ASIC), a field programmable gate array (FPGA), etc., but one or more embodiments are not limited thereto.

The memory 33 may temporarily or permanently store data processed by the apparatus 31 for inspecting a display panel. The memory 33 may include a permanent mass storage device such as random-access memory (RAM), read-only memory (ROM), and a disk drive, but one or more embodiments are not limited thereto.

The input signal application unit 37 may generate an input signal in the form of a repeating pulse and apply the input signal to the display panel 10 to be inspected. To this end, the apparatus 31 for inspecting a display panel may include input pads that may be brought into contact with pads of the pad area PADA of the display panel 10 shown in FIG. 5. Alternatively, the apparatus 31 for inspecting a display panel may include input pads that may be brought into contact with test pads of the display panel 10 shown in FIG. 5.

The luminance measurement unit 39 may measure luminance of the display area DA of the display panel 10 over time. For example, when only red sub-pixels from among sub-pixels included in the display area DA of the display panel 10 are allowed to emit light, luminance data obtained by the luminance measurement unit 39 may appear as in the graph shown in FIG. 6. Likewise, when only green sub-pixels from among sub-pixels included in the display area DA of the display panel 10 are allowed to emit light, luminance data obtained by the luminance measurement unit 39 may appear as in the graph shown in FIG. 8. In addition, when only blue sub-pixels from among sub-pixels included in the display area DA of the display panel 10 are allowed to emit light, luminance data obtained by the luminance measurement unit 39 may appear as in the graph shown in FIG. 10.

The differential circuit unit 35 may generate differential data that is a result of differentiating luminance data according to time obtained by the luminance measurement unit 39 with respect to time. When the luminance data according to time obtained by the luminance measurement unit 39 is input to the differential circuit unit 35, a first-order differential value with respect to time of the luminance data according to time obtained by the luminance measurement unit 39 may be obtained. When data of the first-order differential value with respect to time is input to the differential circuit unit 35, a second-order differential value with respect to time of the luminance data according to time obtained by the luminance measurement unit 39 may be obtained. As described above, pairs of the first-order differential value with respect to time and the second-order differential value with respect to time of the luminance data according to time obtained by the luminance measurement unit 39 may be obtained using the differential circuit unit 35. Temporary data or final data in a process of obtaining information about such pairs may be stored in the memory 33.

The apparatus 31 for inspecting a display panel may determine whether the display panel 10 is normal or not by using the pairs obtained as described above. A concrete method of determining, by the apparatus 31 for inspecting a display panel, whether the display panel 10 is normal or not is the same as that described above with reference to FIGS. 6-11.

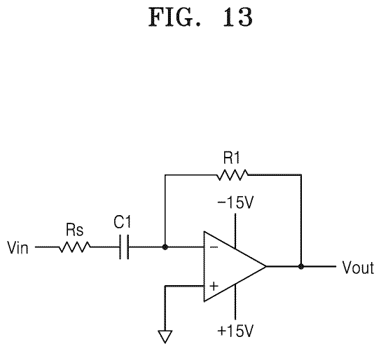

FIG. 13 is a circuit diagram showing the differential circuit unit 35 that may be included in the apparatus 31 of FIG. 12. The circuit diagram of FIG. 13 is an example circuit diagram of the differential circuit unit 35, and the differential circuit unit 35 included in the apparatus 31 for inspecting a display panel according to the present embodiment is not limited by the circuit diagram shown in FIG. 13.

As shown in FIG. 13, the differential circuit unit 35 may include one operational amplifier (OP amp), one capacitor C1, and two resistors R1 and Rs. One end of the resistor R1 may be electrically connected to a—terminal of the OP amp, and the other end of the resistor R1 may be electrically connected to an output terminal Vout of the OP amp. One end of the capacitor C1 may be electrically connected to the—terminal of the OP amp, the other end of the capacitor C1 may be electrically connected to one end of the resistor Rs, and the other end of the resistor Rs may be electrically connected to an input terminal Vin of the differential circuit unit 35. A +terminal of the OP amp may be grounded.

By inputting luminance data obtained by the luminance measurement unit 39 to the input terminal Vin of the differential circuit unit 35, data for a first-order differential value with respect to time may be obtained from the output terminal Vout of the differential circuit unit 35. When the data for a first-order differential value with respect to time is input to the input terminal Vin of the differential circuit unit 35, data for a second-order differential value with respect to time may be obtained from the output terminal Vout of the differential circuit unit 35. The data for a first-order differential value with respect to time and the data for a second-order differential value with respect to time may each be stored in the memory 33, and thus, pairs of the first-order differential value with respect to time and the second-order differential value with respect to time of the luminance data according to time obtained by the luminance measurement unit 39 may be obtained. Concrete operations and methods of determining whether the display panel 10 is normal or not by using such pairs are the same as those described above with reference to FIGS. 6-11.

In such an apparatus 31 for inspecting a display panel according to the present embodiment, luminance in the display area DA is measured by applying an input signal in the form of a repeating pulse to the display panel 10, and then, whether the display panel 10 is normal or not is determined by obtaining the response graph as shown in FIGS. 7, 9 and/or 11. Accordingly, when the apparatus for inspecting a display panel according to the present embodiment is used, luminance is measured for a very short time, and whether the display panel 10 is normal or not is determined based on the luminance. Accordingly, whether the display panel 10 is normal or not may be determined simply, quickly, and intuitively.

The apparatus 31 for inspecting a display panel, according to the present embodiment, may be used not only for the display panel 10 in a manufacturing process but also for a display apparatus including the display panel 10. Accordingly, the above apparatus 31 may be used to not only inspect whether a defect occurs during a process of manufacturing the display panel 10 but also determine whether a display element deteriorates during a process of using the display apparatus.

According to one or more of the above embodiments, a method and apparatus for inspecting a display panel, in which whether a display panel is normal or not may be determined quickly, may be implemented. However, one or more embodiments are not limited by such an effect.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A method of inspecting a display panel, the method comprising:
obtaining luminance data by measuring, over time, luminance of a display area of the display panel to which an input signal comprising a plurality of pulses is applied;
obtaining pairs of a first-order differential value with respect to time and a second-order differential value with respect to time, from the luminance data or from a graph of luminance over time corresponding to the luminance data;
obtaining a response graph based on the pairs by setting one of an x-axis and a y-axis as an axis of the first-order differential value with respect to time and another as an axis of the second-order differential value with respect to time; and
determining whether the display panel is normal or not according to the response graph.

2. The method of claim 1, wherein the determining comprises determining whether the display panel is normal or not, based on an internal area of the response graph.

3. The method of claim 2, wherein the determining comprises determining the display panel to be abnormal, when the internal area of the response graph is greater than a preset value.

4. The method of claim 1, wherein the determining comprises determining the display panel to be abnormal, when a maximum width of the response graph in an x-axis direction is greater than a preset value.

5. The method of claim 1, wherein the determining comprises determining the display panel to be abnormal, when a maximum width of the response graph in a y-axis direction is greater than a preset value.

6. The method of claim 1, wherein the determining comprises determining the display panel to be abnormal, when a maximum value of the response graph in an x-axis direction is greater than a preset maximum value, or when a minimum value of the response graph in the x-axis direction is less than a preset minimum value.

7. The method of claim 1, wherein the determining comprises determining the display panel to be abnormal, when a maximum value of the response graph in a y-axis direction is greater than a preset maximum value, or when a minimum value of the response graph in the y-axis direction is less than a preset minimum value.

8. The method of claim 1, wherein the obtaining of the pairs comprises obtaining the pairs by inputting the luminance data to a differential circuit unit.

9. An apparatus for inspecting a display panel, the apparatus comprising:
an input signal application unit configured to apply an input signal comprising a plurality of pulses to the display panel;
a luminance measurement unit configured to measure luminance of a display area of the display panel over time; and
a differential circuit unit configured to differentiate, with respect to time, luminance data over time obtained by the luminance measurement unit,
wherein whether the display panel is normal or not is determined using pairs of a first-order differential value with respect to time and a second-order differential value with respect to time of the luminance data over time obtained by the luminance measurement unit, the pairs being obtained by the differential circuit unit.

10. The apparatus of claim 9, wherein a response graph is obtained based on the pairs by setting one of an x-axis and a y-axis as an axis of the first-order differential value with respect to time and another as an axis of the second-order differential value with respect to time,
wherein whether the display panel is normal or not is determined based on the response graph.

11. The apparatus of claim 10, wherein whether the display panel is normal or not is determined based on an internal area of the response graph.

12. The apparatus of claim 11, wherein the display panel is determined to be abnormal when the internal area of the response graph is greater than a preset value.

13. The apparatus of claim 10, wherein the display panel is determined to be abnormal when a maximum width of the response graph in an x-axis direction is greater than a preset value.

14. The apparatus of claim 10, wherein the display panel is determined to be abnormal when a maximum width of the response graph in a y-axis direction is greater than a preset value.

15. The apparatus of claim 10, wherein the display panel is determined to be abnormal when a maximum value of the response graph in an x-axis direction is greater than a preset maximum value, or when a minimum value of the response graph in the x-axis direction is less than a preset minimum value.

16. The apparatus of claim 10, wherein the display panel is determined to be abnormal when a maximum value of the response graph in a y-axis direction is greater than a preset maximum value, or when a minimum value of the response graph in the y-axis direction is less than a preset minimum value.
